(19) United States
(12) Patent Application Publication
(10) Pub. No.: US 2012/0209769 A1
(43) Pub. Date: Aug. 16, 2012

(54) MONEY TRANSFER SYSTEM FOR SENDING MONEY TO AN INSTITUTION FOR THE BENEFIT OF A RECEIVER ASSOCIATED WITH THE INSTITUTION

(75) Inventors: Dennis J. Rolfs, Maple Grove, MN (US); Katie Hutcheson, Durango, CO (US); Gordon L. Smith, Littleton, CO (US); Terry L. Wallace, Tyler, TX (US)

(73) Assignee: MONEYGRAM INTERNATIONAL, INC., St. Louis Park, MN (US)

(21) Appl. No.: 13/028,688

(22) Filed: Feb. 16, 2011

(51) Int. Cl. G06Q 40/00

(52) U.S. Cl. 705/44

(57) ABSTRACT

A computer system is operated to transfer money to a receiver via an institution. A send transaction request including a send amount is received from a sender for a money transfer. The sender is prompted to provide identifying information about the institution and the receiver. The identifying information about the receiver includes the receiver's name. A compliance and/or regulatory review of the receiver is then conducted. If the receiver passes the compliance and/or regulatory review, the receiver name and send amount are provided to the institution in a receive transaction.

### TECHNICAL FIELD

The present invention relates to computer systems for money transfers. More particularly, the present invention is a computer system that facilitates transfer of money to an institution for the benefit of a receiver associated with the institution.

### BACKGROUND

A number of businesses offer money transfer and other services through a network of agents. A customer that desires to use these services to transfer money to a third party can take the money to an agent of the money transfer service. The agent accepts the money, obtains necessary information such as the customer's identity and the identity of the receiver, and initiates a transaction. The money is then made available to the receiver by another agent.

To send money to individuals associated with an institution, such as individuals who are incarcerated or under the care or supervision of an institution (e.g., mental health facility, nursing home, etc.), the sender may only be required to provide an account number associated with the receiver. For example, for an incarcerated individual, the sender may provide the inmate's prison-issued identification number, which also functions as the inmate's account number for receiving money transfers. However, without any further identifying information, it may be difficult for the money transfer service to scrub the receiver's account for fraudulent transactions. Some correctional or care facilities may supply a list of approved recipients for electronic money transfers, but many facilities do not have the resources to maintain such a list. In facilities that provide this information, the onus of fraud prevention is placed on the correctional or care facility, making it difficult for the money transfer service to assure fraud prevention.

### SUMMARY

In one aspect, the present invention relates to a method for operating a computer system to transfer money to an institution for the benefit of a receiver associated with the institution. A send transaction request including a send amount is received from a sender for a money transfer. The sender is prompted to provide identifying information about the institution and the receiver. The identifying information about the receiver includes the receiver's name. A compliance and/or regulatory review of the receiver is then conducted. If the receiver passes the compliance and/or regulatory review, the receiver name and send amount are provided to the institution in a receive transaction. An interface to accept or reject the receive transaction may then be provided to the institution. Funds in the send amount are then released for access by the institution if the institution accepts the receive transaction.

In another aspect, the present invention relates to a system configured to transfer money to an institution for the benefit of a receiver associated with the institution. The system includes a server that communicates with a plurality of computers. The server receives a send transaction request including a send amount from a sender for a money transfer. The server then prompts the sender to provide identifying information about the institution and the receiver. The identifying information about the receiver includes a name of the receiver. The server then conducts a compliance and/or regulatory review of the receiver. If the receiver passes the compliance and/or regulatory review, the server provides the receiver name and send amount to the institution in a receive transaction. The server may then provided an interface to the institution to accept or reject the receive transaction. The server then releases funds in the send amount for access by the institution if the institution accepts the receive transaction.

In a further aspect, the present invention relates to a method for operating a computer system to transfer money to a custodial receiver at an institution. A send transaction request including a send amount is received from a sender for a money transfer. The sender is prompted to provide identifying information about the institution and the receiver. The identifying information about the receiver includes a name of the receiver. The sender is also prompted to specify a purpose of use at the institution for the send amount. A compliance and/or regulatory review of the receiver is then conducted. If the receiver passes the compliance and/or regulatory review, a receive transaction is generated including the identifying information about the institution and receiver, send amount, and purpose for the send amount. A user interface accessible by the institution is then generated to alert the institution of the receive transaction. The user interface includes the receiver identifying information, send amount, and purpose associated with the receive transaction. The user interface also includes an interface to accept or reject the receive transaction may then be provided to the institution.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an embodiment of a system for transferring money to an institution for the benefit of a receiver associated with the institution.

FIG. 2 is a flow diagram of an embodiment of a process for sending money to an institution for the benefit of a receiver associated with the institution.

FIG. 3 is a flow diagram of an embodiment of a process for sending money to an institution for the benefit of a receiver associated with the institution and providing the institution with a user interface regarding the money transfer.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

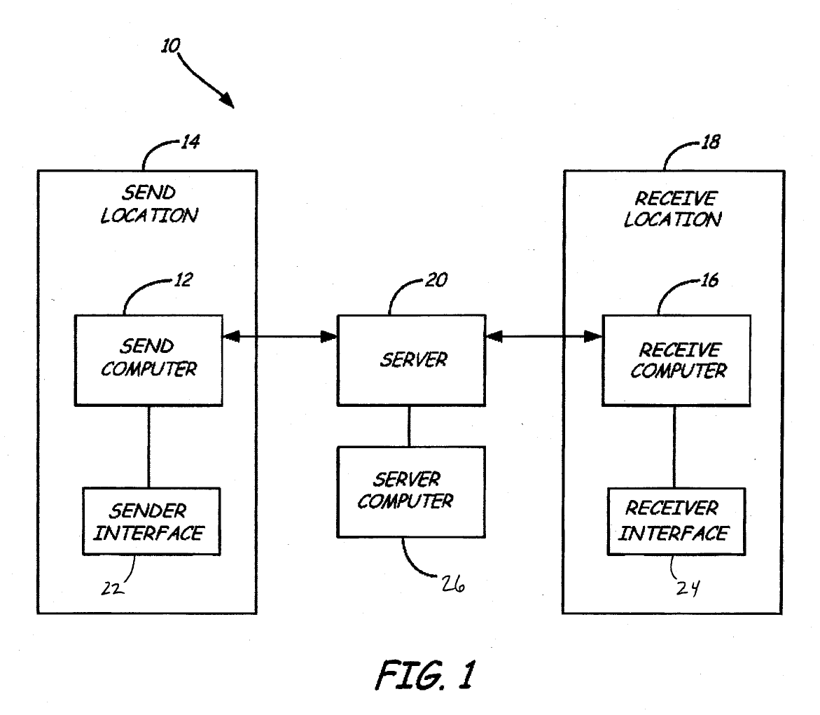

FIG. 1 is a block diagram of an embodiment of a system 10 for sending and receiving money transfers. System 10 includes a send computer 12 at a send location 14 and a receive computer 16 at a receive location 18. The send computer 12 and the receive computer 16 communicate with a central server 20, for example via a communication network such as the internet. In some embodiments, a sender interface 22 is connected to the send computer 12, and a receiver interface 24 is connected to the receive computer 16. The system 10 facilitates the sending of money transfers through the send computer 12, and the receipt of the money transfer through the receive computer 16. As will be described in more detail herein, the receive computer 16 is associated with an institution (e.g., located at the institution or accessible by the institution), such as a correctional facility, custodial care facility, court, or school and the money transfer is sent to a receiver associated with the institution (e.g., incarcerated individual, persons in a care facility such as a nursing home, child support beneficiary, alimony beneficiary, student). The server 20 coordinates the requesting and approval processes for sending and receiving money transfers.

The send location 14 may be a facility that is approved by a financial services organization to send purchase requests for money transfers to the server 20. The send location 14 may be a store or dedicated location that provides redemption services for money transfers. Alternatively, the send location 14 may access a computer remotely, such as via a telephone call or the internet. The send computer 12 is operated by an agent at the approved send location 14. The send computer 12 may include software that facilitates entry of information to request sending the money transfer for subsequent transmission to the server 20 for approval. The agent at the send location 14 may also review purchaser identification and accept funds from the sender of the money transfer. In some embodiments, the agent accepts funds on behalf of the financial services organization. The send location 14 may also include a telephone (not shown) or other voice communications device to contact the financial services organization if questions arise during the money transfer request process. While a single send location 14 is shown in FIG. 1, in actual implementation, the system 10 includes a plurality of send locations 14 that each includes a send computer 12 that communicates with the server 20.

In alternative embodiments, the send computer 12 may be any computer configured to provide information to the server 20 via a secure internet or server connection. For example, the send computer 12 may be a home computer, kiosk, or other interactive device. The send computer 12 may include a web browser or other application that provides a user interface to enter information to send a money transfer. The web browser may allow for entry of sender identification information and sender account information, the latter of which authorizes withdrawal of funds from an account with a financial institution to fund the money transfer. As another example, the send computer 12 may be configured to receive money transfer send information from the sender via telephone or interactive voice recognition systems. As a further example, a telephone at the send location 14 may be used to contact a call center (not shown) to initiate a send request to the server 20.

The receive location 18 may be an institution that is approved by the financial services organization to receive money transfers for the benefit of a receiver associated with the institution and issue funds to the money transfer receivers. As discussed above, the receive location 18 may be institutions such as a correctional facility, custodial care facility, a court, or a school. The receive computer 16 at the receive location 18 may be operated by an approved employee of the institution using the receiver interface 24. The receive computer 18 may include software that facilitates retrieval of information about money transfers sent to the institution for the benefit of receivers associated with the institution. The employee operating the receive computer 16 at the receive location 18 may also, in some cases, review the information associated with the money transfer, such as the amount and purpose of the money transfer funds. If approved, the employee issues funds to the money transfer receiver's account at the institution. The receive location 18 may also include a telephone or other voice communications device to contact the financial services organization if questions arise during the money transfer receipt process. While a single receive location 18 is shown in FIG. 1, in actual implementation, the system 10 includes a plurality of receive locations 18 that each includes a receive computer 16 that communicates with the server 20.

The server 20 may be housed and/or operated by or on behalf of the financial services organization that, among other functions, approves and coordinates send transactions of money transfers at the send location 14 and receive transactions of money transfers at the receive location 18. The server 20 facilitates approval of send requests from the send location 14 and receive requests from the receive location 18. In some embodiments, the server 20 is configured to process send and receive requests automatically. In other embodiments, the server 20 provides information to a user at the financial services organization for review and approval. For example, the server 20 may be connected to a computer 26 that provides an interface to a user at the financial services organization to review and approve or deny money transfer send or receive transactions. In some embodiments, the server 20 provides compliance functions for money transfer transaction. The server 20 includes storage capabilities to store information from money transfer send transactions for later retrieval during the money transfer receive approval process. In addition, the server 20 may store other information such as, for example, past customer money transfer send/receive activity, customer account information, and computer identification and log-in information for the send computer 12 and receive computer 16.

As will be described in more detail herein, the system 10 allows a sender to send a money transfer for the benefit of a receiver under the care of or otherwise associated with an institution, without requiring the institution to provide a list of individuals associated with the institution to the financial services organization. By including the receiver's name in the transaction, the financial services organization may then perform a compliance and/or regulatory review of the receiver before allowing transmitting the money transfer to the institution. Consequently, the institution is assured that the transaction is in compliance with relevant anti-money laundering, anti-terrorism, and anti-fraud regulations. In addition, this money transfer process removes the burden on the institution of providing a list of people associated with the institution capable of to the financial services organization.

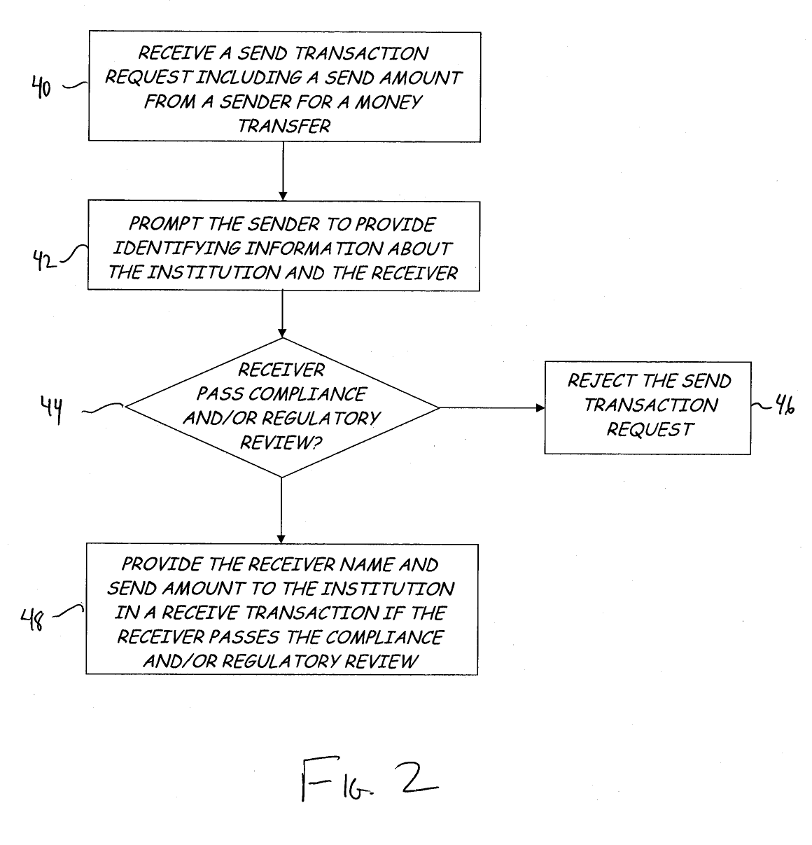

FIG. 2 is a flow diagram of an embodiment of a process for sending money to an institution for the benefit of a receiver associated with the institution. In step 40, the server 20 receives a money transfer send request from the send location 14. For example, as described above, the sender may submit the send request with an agent operating the send computer 12 at the send location 14, via a send computer 12 remotely connected to the server 20, via a self-service kiosk, or via a telephone or other interface for communicating with the server 20. In some embodiments, the send request is configured as a bill payment transaction. The money transfer send request may include information such as sender identification information, the amount of the money transfer, and sender funding source information.

As a part of the send transaction request, in step 42, the send computer 12 then prompts the sender to provide identifying information about the institution and receiver. Identifying information about the institution may include such information as the institution name, address, telephone number, and the like. The identifying information about the receiver may include such information as the receiver name and an receiver identification number that is assigned by the institution. The identifying information may further include a receiver account number, which may be the same as or different than the receiver identification number. The send transaction request, including the sender identification information, amount of money transfer, sender funding source, and institution and receiver identifying information, is then transmitted to the server 20.

When the server 20 receives the send request, the server 20 processes the data associated with the money transfer and initiates a new transaction in the system 10. The server 20 may then conduct a compliance and/or regulatory review of the send transaction request to assure that the receiver is allowed to receive funds. In some embodiments, the server 20 conducts an review to assure compliance with anti-money laundering, anti-terrorism, anti-fraud, and/or other financial compliance regulations, sanctions, and laws. For example, the review may comprise assurances of compliance with Office of Foreign Assets Control (OFAC) sanctions.

If, in decision step 44, the receiver does not pass the compliance and/or regulatory review, then, in step 46, the send transaction request is rejected. The server 20 sends a notification to the send computer 12, which is provided to the sender. At this point, the sender may have an opportunity to amend the send request (e.g., the send amount) to comply with the relevant regulations or statutes preventing approval of the original send request. Alternatively, the sender may be prohibited from submitting a send request to the designated receiver because of the nature of the violation with the relevant regulations and statutes.

If, in decision step 44, the receiver passes the compliance and/or regulatory review, then, in step 48, the receiver name and send amount are provided to the institution in a receive transaction. In some embodiments, the send amount is transferred from the financial services organization to an account (e.g., bank account) associated with the institution, and the financial institution is alerted of the transaction. The send amount may alternatively be made available by other means, such as via an account with the financial services organization.

The institution then makes the send amount available for access by the receiver in an account the receiver has with the institution. For example, in embodiments in which the institution is a correctional or care facility, the receiver may be able to access the funds via one or more accounts the correctional or care facility maintains for the receiver. The accounts may be for specific uses or applications at the correctional or care facility. In embodiments in which the institution is a court, the court may issue the funds directly to the alimony or child support payment recipient, or to an bank account associated with the recipient. In some embodiments, the court may receive the money on behalf of the recipient and direct the money to an account or third-party receiver to maintain the privacy of the recipient. In embodiments in which the institution is a school (e.g., college or university), the school may have one or more vendor accounts associated with the student receiver. For example, the student may have vendor accounts (e.g., for books, food, and tuition), and the send amount is provided to the vendor accounts after approval by the school. The send transaction may also allocate portions of the send amount to different accounts.

In some embodiments, when the financial services organization alerts the institution of the receive transaction, the institution may have the option to accept or reject the receive transaction. For example, the institution may have a list of individuals who cannot receive money transfers for disciplinary or safety reasons. If the institution rejects the receive transaction, the money transfer is sent back to the sender. Otherwise, the institution makes the send amount available in an account the receiver has at the institution, such that the funds are accessible and usable by the receiver.

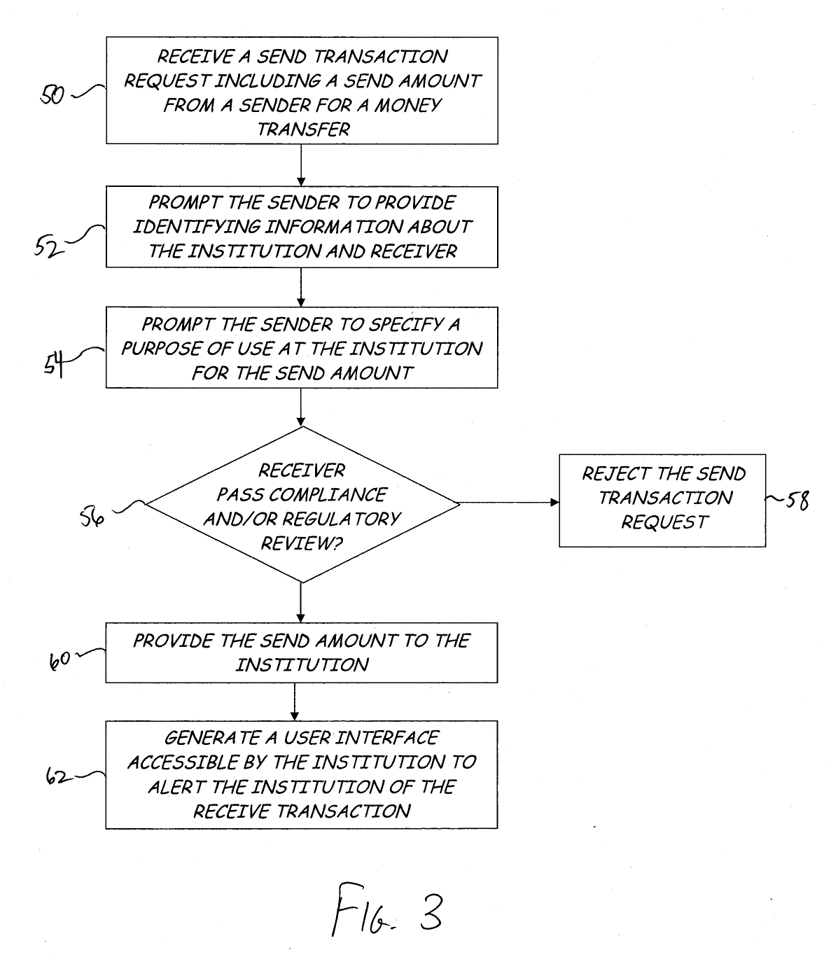

FIG. 3 is a flow diagram of an embodiment of a process for sending money to an institution for the benefit of a receiver associated with the institution and providing the institution with a user interface regarding the money transfer. In step 50, the server 20 receives a money transfer send request from the send location 14, and in step 52, the send computer 12 then prompts the sender to provide identifying information about the institution and receiver. Steps 50 and 52 in the process shown in FIG. 3 are substantially similar to the steps 40 and 42, respectively, described above with regard to FIG. 2.

In this embodiment, in step 54, the sender is additionally prompted to specify a purpose of use at the institution for the send amount. For example, for incarcerated individuals or persons under custodial care, the sender may specify that the money is to be used for personal effects or necessities. The send transaction request, including the sender identification information, amount of money transfer, purpose of use of the send amount, sender funding source, and institution and receiver identifying information, is then transmitted to the server 20.

When the server 20 receives the send request, the server 20 processes the data associated with the money transfer and initiates a new transaction in the system 10. The server 20 may then conduct a compliance and/or regulatory review of the send transaction request to assure that the receiver is allowed to receive funds. The decision step 56 of the compliance and/or regulatory review and the step 58 to reject the send transaction request are substantially similar to the corresponding process steps 44 and 46, respectively, described above with regard to FIG. 2.

If, in decision step 56, the receiver passes the compliance and/or regulatory review, then, in step 60, the send amount is provided to the institution. Similar to the embodiment described above, the send amount may be transferred from the financial services organization to an account (e.g., bank account) associated with the institution. The send amount may alternatively be made available via other means, such as via an account with the financial services organization.

Then, in step 62, the server 20 generates a user interface on the receive computer 16 that is accessible by the institution (e.g., via secure connection) to alert the institution of the receive transaction. In some embodiments, the server 20 provides information about the receive transaction on a web page accessible via a web browser on the receive computer 16. The web page may include such information as the receiver's name, the received amount, and the purpose of use specified by the sender. The web page may include a listing of all receive transactions sent to the institution that are available for transfer to a receiver's account.

In some embodiments, the user interface further comprises a field that allows the institution to accept or reject the listed receive transactions. For example, the institution may have a list of individuals who cannot receive money transfers for disciplinary or safety reasons. In addition, the institution may make a determination of whether the purpose of use specified by the sender is appropriate. If the institution rejects the receive transaction, the money transfer is sent back to the sender. Otherwise, the institution makes the send amount available in an account the receiver has at the institution, such that the funds are accessible and usable by the receiver.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method for operating a computer system to transfer money to a receiver care of an institution, the method comprising:
receiving a send transaction request from a sender for a money transfer, the send transaction request including a send amount;
prompting the sender to provide identifying information about the institution and the receiver, the identifying information about the receiver including a name of the receiver;
conducting a compliance and/or regulatory review of the receiver;
providing the receiver name and send amount to the institution in a receive transaction if the receiver passes the compliance and/or regulatory review;
providing the institution with an interface to accept or reject the receive transaction; and
releasing funds in the send amount for access by the institution if the institution accepts the receive transaction.

2. The method of claim 1, wherein the prompting step further comprises prompting the sender to specify a purpose of use at the institution for the send amount.

3. The method of claim 1, wherein the releasing step comprises:
transferring the send amount to an account associated with the institution.

4. The method of claim 1, wherein the step of providing the receiver name and send amount to the institution comprises:
generating a user interface accessible by the institution to alert the institution of the receive transaction, the user interface including the receiver identifying information and send amount associated with the receive transaction.

5. The method of claim 4, wherein the generating step comprises:
generating a web page that includes all receive transactions associated with the institution.

6. The method of claim 4, wherein the user interface includes a field that allows the institution to accept or reject the receive transaction.

7. The method of claim 1, wherein the institution is selected from the group consisting of a correctional facility, a care facility, a court, and a school.

8. The method of claim 1, wherein the identifying information about the receiver further comprises an identification number associated with the receiver at the institution.

9. A system configured to transfer money to a receiver care of an institution, the system comprising:
a server that communicates with a plurality of computers, the server configured to:
receive a send transaction request from a sender for a money transfer, the send transaction request including a send amount;
prompt the sender to provide identifying information about the institution and the receiver, the identifying information about the receiver including a name of the receiver;
conduct a compliance and/or regulatory review of the receiver;
provide the receiver name and send amount to the institution in a receive transaction if the receiver passes the compliance and/or regulatory review;
provide the institution with an interface to accept or reject the receive transaction; and
release funds in the send amount for access by the institution if the institution accepts the receive transaction

10. The system of claim 9, wherein the server is further configured to prompt the sender to specify a purpose of use at the institution for the send amount.

11. The system of claim 9, wherein, to provide the send amount to the institution, the server is configured to transfer the send amount to an account associated with the institution.

12. The system of claim 9, wherein the server is further configured to generate a user interface accessible by the institution to alert the institution of the receive transaction, the user interface including the receiver identifying information and send amount associated with the receive transaction.

13. The system of claim 12, wherein the user interface comprises a web page that includes all receive transactions associated with the institution.

14. The system of claim 12, wherein the user interface includes an interface that allows the institution to accept or reject the receive transaction.

15. The system of claim 9, wherein the institution is selected from the group consisting of a correctional facility, a care facility, and a court.

16. A method for operating a computer system to transfer money to a custodial receiver at an institution, the method comprising:
receiving a send transaction request from a sender for a money transfer, the send transaction request including a send amount;
prompting the sender to provide identifying information about the institution and receiver, the identifying information about the receiver including a name of the receiver;
prompting the sender to specify a purpose of use at the institution for the send amount;
conducting a compliance and/or regulatory review of the receiver;
generating a receive transaction if the receiver passes the compliance and/or regulatory review, the receive transaction including the identifying information about the institution and receiver, send amount, and purpose for the send amount; and
generating a user interface accessible by the institution to alert the institution of the receive transaction, the user interface including the receiver identifying information, send amount, purpose associated with the receive transaction, and a field to accept or reject the receive transaction.

17. The method of claim 16, and further comprising:
transferring the send amount to an account associated with the institution if the receive transaction is accepted.

18. The method of claim 16, wherein generating a user interface comprises:
generating a web page that includes all receive transactions associated with the institution.

19. The method of claim 16, wherein the identifying information about the receiver further comprises an identification number associated with the receiver at the institution.
